(19) United States
(12) Patent Application Publication
(10) Pub. No.: US 2015/0108968 A1
(43) Pub. Date: Apr. 23, 2015

(54) Rotary Encoder with Self-Sustained Supply of Energy

(71) Applicant: SICK STEGMANN GmbH, Donaueschingen (DE)

(72) Inventors: Stefan BASLER, Donaueschingen (DE); Reinhold MUTSCHLER, Donaueschingen (DE); Dominik DILGER, Donaueschingen (DE)

(21) Appl. No.: 14/464,729

(22) Filed: Aug. 21, 2014

(30) Foreign Application Priority Data
Oct. 21, 2013 (EP) 13189520.3

(51) Int. Cl. G01D 5/20

(52) U.S. Cl. CPC G01D 5/204
USPC 324/207.17

(57) ABSTRACT

A rotary encoder has a signal encoding unit fastened at the shaft, a signal detection unit arranged in an axial direction of the shaft disposed opposite to the signal encoding unit, a signal evaluation unit, and an energy generation unit for the generation of electrical energy for the rotary encoder. The energy generation unit has a first element provided at the signal encoding unit and of a second element arranged at the circuit board of the signal evaluation unit. The first and the second element are disposed opposite to one another. The second element has a plurality of coils which are arranged in such a way that two or more coils are displaced by a pole pitch or a multiple of a pole pitch and in that the coils are switched in parallel, in series or in groups.

The present invention relates to a rotary encoder for the detection of information of a rotating shaft.

From the EP 2 159 547 A2 a rotary encoder in accordance with the preamble of the independent claim 1 is known.

Common rotary encoders serve the purpose of detecting measurement parameters, such as angular position, number of rotations, direction of rotation and/or angular accelerations of a rotating shaft of a drive and to forward these to a control for the control and/or regulation of the drive. Hereby the rotary encoders can also be used for the purpose of buffering the detected measurement parameters and to carry out a monitoring of the state by means of a statistical evaluation.

Having regard to such a state monitoring generally not the individual measurement values, but rather their histograms or statistical distributions over time are output, whereby a data compression is achieved. Generally, the detected measurement parameters are transmitted as electrically coded signals to the control in a wire-bound manner, wherein a high demand in cabling results therefrom.

In addition to the cabling for the communication, the supply of energy of the rotary encoder requires further cabling for the detection and buffering of the measurement parameters, whereby the cabling problem is increased.

In order to counteract this problem cable-free rotary encoders are made available which cover their supply of energy through the use of primary batteries or through the use of energy stores that can be charged by means of generators.

Rotary encoders having primary batteries for the supply of energy have the disadvantage that the primary batteries have to be changed, whereby the rotary encoder is intensive in maintenance and thus expensive.

A rotary encoder having a self-sustained supply of energy which does not use a primary battery is, e.g. known in the application of the applicants own European patent published document EP 2 562 512 A1.

In this respect the rotary encoder has an energy supply unit which has a generator and required electronic components, such as e.g. voltage transformer and energy storage.

The rotary encoder has the disadvantage that the construction shape of the generator can only be adapted with a large demand in effort and cost to a current construction space of a rotary encoder and the rotary encoder is also expensive due to the additional components.

It is an object of the present invention to improve a rotary encoder in accordance with the preamble of claim 1 in such a way that the rotary encoder is compact albeit the self-sustaining supply of energy and has an improved voltage supply.

This object is satisfied in accordance with the invention by a rotary encoder having the features of the independent claim 1.

By means of the integrated arrangement of the elements of the different units a compact arrangement and/or a compact assembly of the rotary encoder is possible. Additionally, the energy generation unit assembled in this way with encoders of different construction shape can easily be matched and installed.

In accordance with a preferred embodiment the first element of the energy generation unit is composed of at least one magnetic element magnetized axially in multipolar form at both sides or in multipolar form at one side.

Advantageously, the magnetic element is configured as a ring magnet, a disc magnet or as a plurality of individual magnets with alternating pole alignment.

In accordance with a further embodiment the second element of the energy generation unit is composed of at least one coil which is configured in the SMD manner of construction or as an in particular multi-layered planar coil, wherein the coil is assembled at the circuit board or is worked into the circuit board in an integrated manner. Hereby the abbreviation SMD relates to the general designation “Surface Mounted Device”. This means the coil is assembled in such a way that it can be mounted at the surface of an electronic element, in particular at a circuit board. Hereby, additional components, such as e.g. a separate generator, can be saved.

Advantageously, respectively two or more coils are arranged displaced by a one and a third (1⅓) of a pole pitch. Through the displaced arrangement and the series or parallel circuit resulting from this consideration, the coils can satisfy a requirement for an increased voltage or a reduced internal resistance. A voltage can be generated with three or more phases through a suitable arrangement and switching, the voltage resulting in a direct voltage having a relatively small waviness after a rectification.

Furthermore, it is advantageous to use SMD coils, whereby a very flexible arrangement is possible. Suitable coils have a diameter of 3 mm at an inductivity of more than 1 mH (Milli-Henry). Having regard to the mechanical arrangement unshielded coils are particularly advantageous in this connection.

In accordance with a further embodiment, a multi-layered planar coil is directly integrated into the circuit board, wherein layers of ferrite material are embedded in the circuit board and/or copper surfaces are introduced around the planar coil. Through the provision of the layers of ferrite material into the circuit board the effectivity of the multi-layered planar coil can be improved, wherein the copper surfaces in turn serve as a screen and prevent that the eddy currents generated by the rotating magnets have an interfering effect with respect to the remaining circuit.

In accordance with a further embodiment, the signal encoding unit has a mount fastened to the shaft and an optically, capacitively or inductively scanable dimensional scale, wherein the dimensional scale is fastened at a side of the mount disposed facing the signal evaluation unit. Advantageously, the dimensional scale is formed from the first element of the energy generation unit. Hereby, further additional components can be saved. A compact design of the rotary encoder is enabled in particular through the integrated assembly of the energy generation unit in the signal encoding unit and the signal detection unit, through the use of the functional elements of the signal encoding unit and of the signal detection unit for the energy generation unit.

In accordance with a further embodiment, the signal detection unit is composed of at least one magnetic field sensor or of conductor tracks arranged in the circuit board, wherein the conductor tracks can have an interaction with the first element of the energy generation unit, in particular with the magnetic element.

It is further advantageous that the second element of the energy generation unit is applied at a first side at a carrier, which represents a magnetic yoke and is arranged at a second side at a flex connector disposed opposite to the first side; and wherein the flex connector is electrically connected to the circuit board and serves as a switch carrier for the second element.

In accordance with a further embodiment, the magnetic field sensor and the dimensional scale are arranged in a flush manner at a middle axis of the shaft and the first and the second element of the energy generation unit are arranged spaced apart radially from the middle axis.

In accordance with a further embodiment, the signal evaluation unit has a rectifier circuit in order to rectify an alternating voltage generated by the energy generation unit and has an energy store for the storage of an electrical energy generated by the energy generation unit.

In accordance with a further embodiment, the signal evaluation has a state monitoring unit and an in particular wireless communication unit in order to communicate data detected by the signal detection unit to the control.

Furthermore, the signal encoding unit in accordance with a further embodiment has a transmission fastened at the shaft, wherein the first element of the energy generation unit is attached at a transmission element, in particular at a planetary carrier of the transmission such that the first element of the energy generation unit attached at the transmission element is arranged disposed opposite to the second element of the energy generation unit.

Albeit a low number of rotations of the shaft, a high number of rotations of the first element, in particular of the magnet, of the energy generation unit is hereby achieved through the transmission, such that sufficient energy can be generated for the rotary encoder. This embodiment is particularly suitable for rotary encoders which are typically used at low numbers of rotations. On the other hand, a maximum allowable number of rotations is thereby limited.

A very compact assembly of the rotary encoder results in accordance with the invention, the rotary encoder having both a self-sustained supply of energy, as well as wireless communication of the detected data.

Preferred embodiments and designs, as well as further advantages of the invention can be found in the dependent claims, the subsequent description and the drawings.

In the following the invention will be explained in detail by means of embodiments with reference to the drawing. In the drawing there is shown:

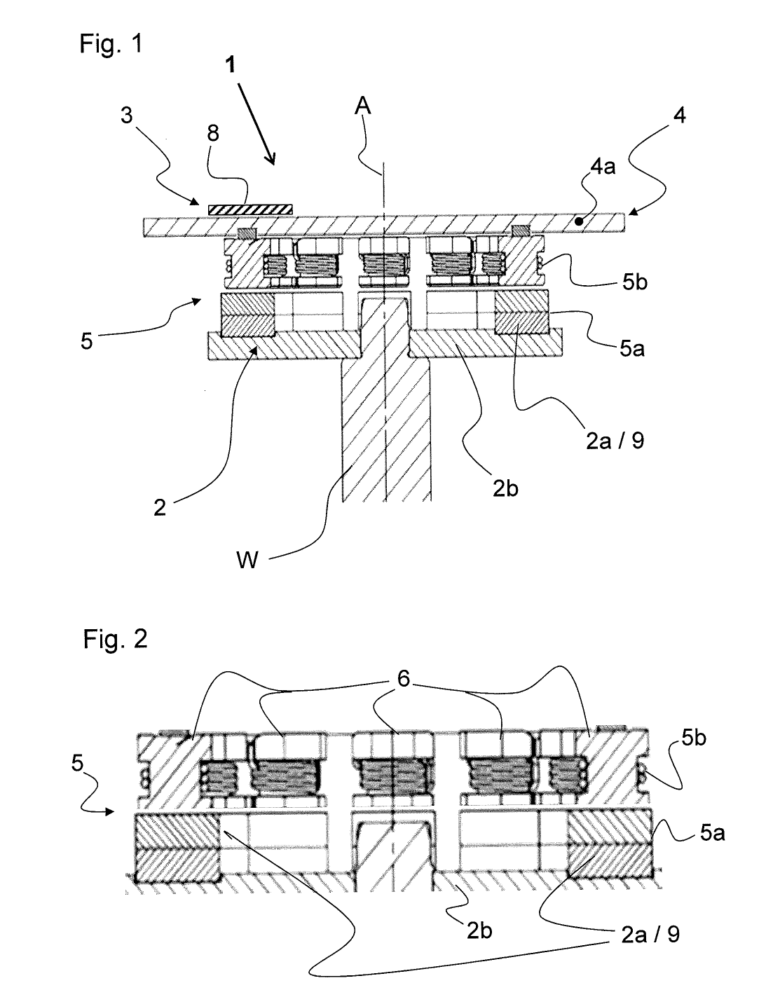

FIG. 1 a schematic representation of the core elements of a rotary encoder in accordance with the invention;

FIG. 2 a schematic detailed view of an embodiment in accordance with the invention of the energy generation unit;

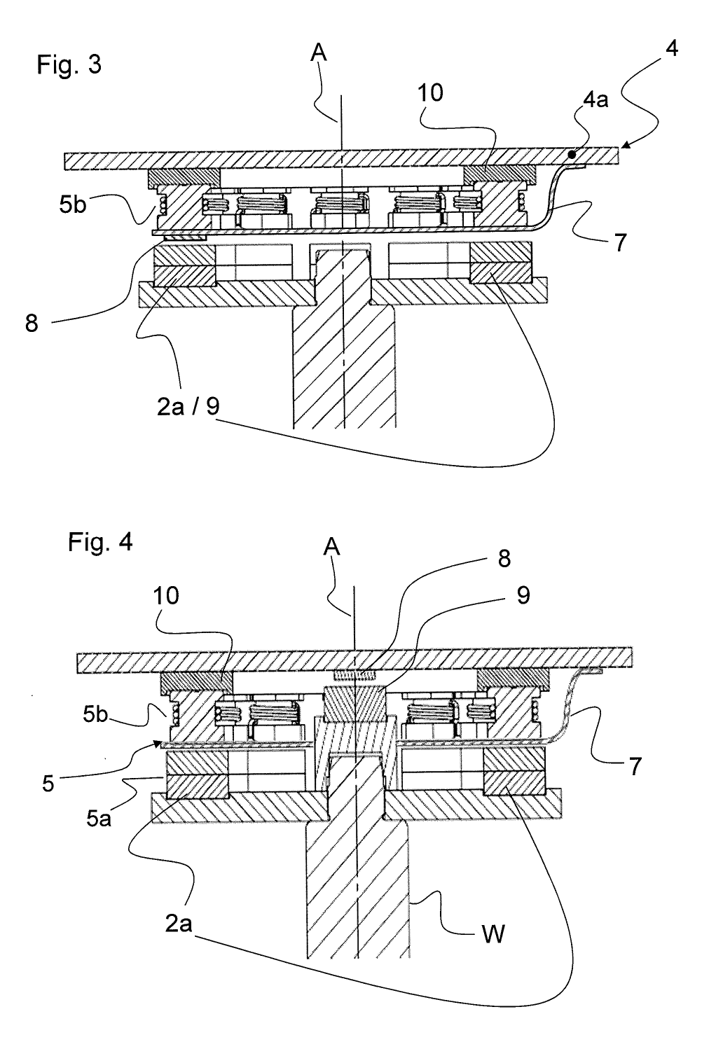

FIG. 3 a schematic representation of an embodiment of a rotary encoder in accordance with the invention;

FIG. 4 a schematic representation of a further embodiment of a rotary encoder in accordance with the invention; and

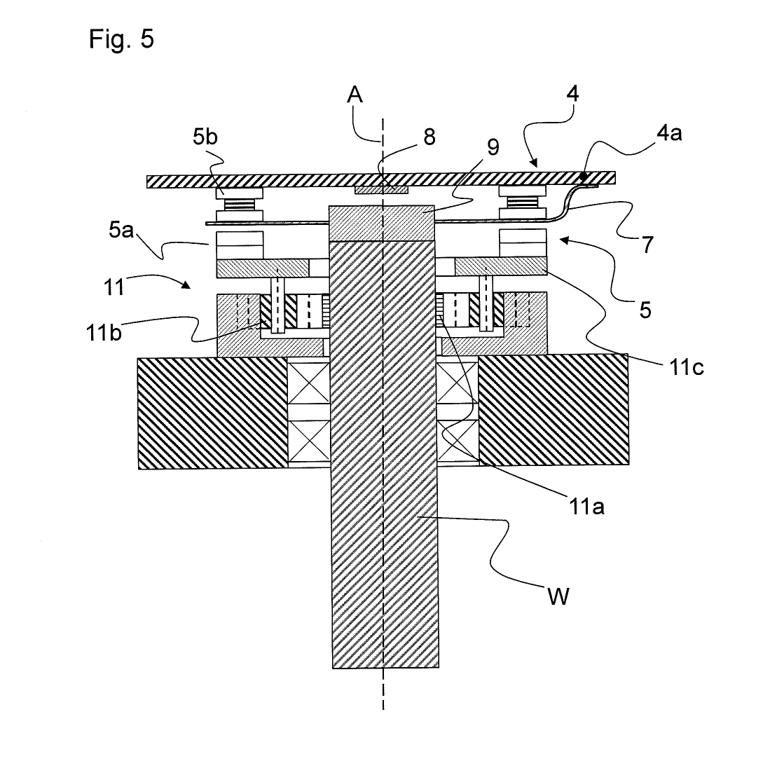

FIG. 5 a schematic representation of a further embodiment of a rotary encoder in accordance with the invention.

In FIG. 1 a schematic illustration of the core elements of a rotary encoder 1 in accordance with the invention for the detection of information of a rotating shaft W is shown. The rotary encoder has a signal encoding unit 2, a signal detection unit 3, a signal evaluation unit 4 and an energy generation unit 5.

In this connection the signal encoding unit 2 is fastened at the shaft W. The signal detection unit 3 is arranged disposed opposite of the signal encoding unit 2 in an axial direction of the shaft W. The signal evaluation unit 4 has a circuit board 4a which is arranged spaced apart with respect to the shaft W in an axial direction. The signal detection unit 3 is composed of at least one magnetic field sensor 8 or of conductor tracks arranged in the circuit board 4a, wherein the conductor tracks have an interaction with a first element 5a of the energy generation unit 5.

The energy generation unit 5 for the generation of electrical energy for the rotary encoder 1 is arranged between the signal encoding unit 2 and the signal detection unit 4, wherein the energy generation unit comprises the first element 5a, which is provided at the signal encoding unit 2, and a second element 5b, which is provided at the circuit board 4a of the signal evaluation unit 4. The first element 5a of the generation unit 5 in turn is composed of at least one magnetic element 2a magnetized axially in multipolar form at both sides or in multipolar form at one side, wherein the magnetic element 2a is advantageously configured as a ring magnet, a disc magnet, or a plurality of individual magnets with an alternating pole alignment.

The signal encoding unit 2 is composed of a mount 2b which is mounted at the shaft W and of a dimensional scale 9 which can be scanned in an optical, capacitive or inductive manner, wherein the dimensional scale 9 is fastened at a side of the mount 2b facing the signal evaluation unit 4. The mount 2b is advantageously configured as a magnetically conducting magnet carrier, such that it can serve as a magnetic yoke in order to avoid interactions with bearings possibly used in the rotary encoder 1.

The dimensional scale 9 is typically scanned optically, capacitively or inductively by the signal detection unit 3, from which the information of the rotating shaft W with respect to the angle of rotation, the angular speed, the direction of rotation, the angular acceleration, a number of rotations or the like can be derived.

In accordance with the invention the dimensional scale 9 is formed from the first element 5a of the energy generation unit 5 such that the magnetic element 2a represents the dimensional scale 9 of the signal encoding unit 2 in an embodiment.

The second element 5b of the energy generation unit 5 is composed of at least one coil 6 which is in an SMD manner of construction or is configured as a planar coil, in particular as a multi-layered planar coil. A coil 6 can be assembled at the circuit board 4a of the signal evaluation unit 4 in an SMD manner of construction, this means as a surface mounted device. The at least one coil 6 is integrated into the circuit board 4a in particular as a multi-layered planar coil. Hereby layers of ferrite material can be embedded in the circuit board 4a such that the effect of the planar coil is amplified. Additionally it can be advantageous to provide copper surfaces in the circuit board 4a around the planar coil such that eddy currents generated by the rotating first element 5a of the energy generation unit 5 and/or of the magnetic element 2a of the signal encoding unit 2 do not have an interfering effect with respect to the remaining circuit.

As is shown in FIG. 2 the second element 5b of the energy generation unit 5 in accordance with the invention is composed of a plurality of coils 6 which are arranged in such a way that respectively two or more coils 6 are displaced by a pole pitch or a multiple of a pole pitch of the magnetic element 2a. Advantageously, the coils 6 can be switched in series or in parallel on a consideration of the polarity, such that a higher voltage or a lesser internal resistance can be enabled in accordance with a requirement. Through a suitable arrangement and switching a voltage can be generated with two or three or more phases which following a rectification, result in a direct voltage with a relatively small waviness.

Having regard to a rotation of the shaft W the first element 5a of the energy generation unit 5 and/or of the magnetic element 2a of the signal encoding unit 2 induce a voltage in the second element 5b and/or in the coils 6 of the energy generation unit 5 such that an alternating voltage is generated. The generated alternating voltage is rectified by means of a rectifier circuit of the signal evaluation unit 4 and is transformed into electrical energy, such that the electrical energy is made available to the rotary encoder 1 or can be stored in an energy store.

As the first element 5a of the energy generation unit 5 and/or of the magnetic element 2a of the signal encoding unit 2 in accordance with an embodiment simultaneously represents the dimensional scale 9 of the signal encoding unit 2 the at least one magnetic field sensor 8 is stimulated by the rotation such that output signals can be detected which represent the measurement parameters, angle of rotation, angular speed, direction of rotation, angular acceleration, number of rotations of the shaft W or the like.

In the embodiment shown in FIG. 3 of the rotary encoder 1 in accordance with the invention the second element 5b of the energy generation unit 5 is connected at a first side to the circuit board 4a of the signal evaluation 4 by means of a carrier 10 so that the carrier 10 forms a magnetic yoke. The second element 5b is arranged at a flex connector 7 at a second side disposed opposite to the first side, wherein the flex connector 7 is electrically connected to the circuit board 4a and serves as a switch carrier for the second element 5b.

Hereby the magnetic field sensor 8 is arranged at the side of the flex connector 7 which is disposed opposite to the side at which the second element 5b is arranged. Hereby the magnetic field sensor 8 and the first element 5a of the energy generation unit 5 and/or of the magnetic element 2a of the signal encoding unit 2 are arranged directly opposite one another such that the selected output signals are strong enough for the evaluation also without an amplification.

A further development of the described embodiment in the FIG. 3 is illustrated in FIG. 4, wherein, in contrast to the embodiment shown in the FIG. 3, the magnetic field sensor 8 and the dimensional scale 9 of the signal encoding unit 2 are arranged in a flush manner at a middle axis A of the shaft W. The first and the second element 5a, 5b of the energy generation unit 5 are arranged spaced apart radially from the middle axis A. Hereby an unambiguous determination of the absolute position of the shaft W is given. This means that a determination of an unambiguous angular information is possible over 360°, albeit the use of a plurality of individual magnets or of magnets in multipolar form, with respect to a simultaneous energy generation and signal generation for the position determination. Furthermore, a possible interference of the magnetic fields is reduced at the signal evaluation through the use of a separate dimensional scale 9 and of a separate magnetic element 2a.

Furthermore, the signal evaluation unit 4 has a rectifier circuit which rectifies an alternating voltage generated by the energy generation unit 5. The generated electrical energy can be stored in an energy store which is likewise associated with the signal evaluation unit 4. These elements can be arranged at the circuit board 4a or physically in the vicinity of the signal evaluation unit 4 such that a compact design of the rotary encoder 1 is enabled.

Additionally components, such as a state monitoring unit and an in particular wireless communication unit can be provided at the signal evaluation unit 4, such that detected data or their statistical evaluation of the signal generation units 3 can be transmitted to a non-shown control, wherein the supply of energy of the units of the rotary encoder 1 is ensured by the energy generation unit 5.

In the FIG. 5 a further embodiment of a rotary encoder 1 in accordance with the invention is schematically shown, wherein a transmission 11 is provided at the shaft W. The transmission 11 has a sun wheel 11a at the drive side which drives a planetary wheel 11b. The planetary wheel 11b is fixedly connected to a planetary carrier 11c such that the planetary carrier 11c serves as the output of the transmission 11.

Hereby the transmission 11 fastened at the shaft W represents a part of the signal encoding unit 2, wherein the first element 5a of the energy generation unit 5 is fastened to a transmission element, in particular to the planetary carrier 11c, of the transmission 11, such that the first element 5a of the energy generation unit 5 fastened at the transmission element is arranged disposed opposite to the second element 5b of the energy generation unit 5.

The planetary carrier 11c having the first element 5a of the energy generation unit 5 is arranged disposed opposite the circuit board 4a of the signal evaluation unit 4 such that the second element 5b, this means the coils 6, of the energy generation unit 5 attached at the circuit board 4a by means of the flex connector 7 is coaxial with the first element 5a. The dimensional scale 9 is fastened at the shaft 8 and the magnetic field sensor 8 is likewise arranged disposed coaxially opposite.

When the shaft W rotates, the sun wheel 11a drives the transmission 11 of the planetary wheel 11b such that the planetary carrier 11c fixedly connected to the planetary wheel 11b rotates the first element 5a of the energy generation unit 5 arranged at the planetary carrier 11c with a number of rotations, corresponding to a gear ratio of the transmission, the number of rotations being higher than the number of rotations of the shaft W.

Hereby a high number of rotations of the first element 5a, in particular of the magnetic element 2a, of the energy generation unit 5 is achieved by the transmission 11, albeit a lower number of rotations of the shaft W such that sufficient energy can be produced for the rotary encoder 1. This embodiment is suitable particularly for rotary encoders 1 which are typically used at low numbers of rotations. On the other hand, a maximum allowable number of rotations is thereby limited.

### LIST OF REFERENCE NUMERALS

1 rotary encoder

2 signal encoding unit

2a magnetic element

2b mount

3 signal detection unit

4 signal evaluation unit

4a circuit board

5 energy generation unit

5a first element

5b second element

6 coil

7 flex connector

8 magnetic field sensor

9 dimensional scale

10 carrier

11 transmission

11a sun wheel

11b planetary wheel

11c planetary carrier

A middle axis

W shaft

What is claimed is:

1. A rotary encoder for the detection of information of a rotating shaft, comprising a signal encoding unit which is fastened at the shaft, a signal detection unit which is arranged in an axial direction of the shaft disposed opposite to the signal encoding unit, a signal evaluation unit which has a circuit board arranged spaced apart with respect to the shaft in an axial direction and an energy generation unit for the generation of electrical energy for the rotary encoder, wherein the energy generation unit comprises a first element provided at the signal encoding unit and a second element arranged at the circuit board of the signal evaluation unit; wherein the first and the second elements are arranged disposed opposite one another, wherein the second element of the energy generation unit is composed of a plurality of coils which are arranged in such a way that respectively two or more coils are displaced by a pole pitch or by a multiple of a pole pitch; and wherein the coils are switched in parallel, in series or in groups.

2. The rotary encoder in accordance with claim 1, wherein the first element of the energy generation unit is composed of at least one magnetic element magnetized axially in multipolar form at both sides or in multipolar form at one side.

3. The rotary encoder in accordance with claim 2, wherein the magnetic element is configured as a ring magnet, a disc magnet or as a plurality of individual magnets having alternating pole alignment.

4. The rotary encoder in accordance with claim 1, wherein the second element of the energy generation unit comprises at least one coil which is configured in an SMD manner of construction, wherein the coil is assembled at the circuit board or is incorporated into the circuit board in an integrated manner.

5. The rotary encoder in accordance with claim 1, wherein the second element of the energy generation unit comprises at least one coil which is configured as a planar coil, wherein the coil is assembled at the circuit board or is incorporated into the circuit board in an integrated manner.

6. The rotary encoder in accordance with claim 5, wherein the planar coil is directly integrated into the circuit board and wherein layers of ferrite material are embedded in the circuit board and/or copper surfaces are introduced around the planar coil.

7. The rotary encoder in accordance with claim 6, wherein the planar coil is configured of multiple layers.

8. The rotary encoder in accordance with claim 1, wherein the signal encoding unit has a mount fastened at the shaft and a dimensional scale that can be scanned optically, capacitively or inductively, wherein the dimensional scale is fastened at a side or the mount facing the signal evaluation unit.

9. The rotary encoder in accordance with claim 8, wherein the dimensional scale is formed from the first element of the energy generation unit.

10. The rotary encoder in accordance with claim 1, wherein the signal detection unit is composed of at least one magnetic field sensor and/or of conductor tracks arranged in the circuit board, wherein the conductor tracks have an interaction with the first element of the energy generation unit.

11. The rotary encoder in accordance with claim 1, wherein the second element of the energy generation unit is applied at a first side at a support which represents a magnetic yoke and is connected to the circuit board and is arranged at a flex connector at a second side disposed opposite to the first side; and wherein the flex connector is electrically connected to the circuit board and serves as a switch support for the second element.

12. The rotary encoder in accordance with claim 10, wherein the signal encoding unit has a mount fastened at the shaft and a dimensional scale that can be scanned optically, capacitively or inductively, wherein the dimensional scale is fastened at a side or the mount facing the signal evaluation unit; and
wherein the magnetic field sensor and the dimensional scale are arranged in a flush manner at a middle axis of the shaft and the first and the second elements of the energy generation unit are arranged spaced apart radially from the middle axis.

13. The rotary encoder in accordance with claim 12, wherein the dimensional scale is formed from the first element of the energy generation unit.

14. The rotary encoder in accordance with claim 11, wherein the signal encoding unit has a mount fastened at the shaft and a dimensional scale that can be scanned optically, capacitively or inductively, wherein the dimensional scale is fastened at a side or the mount facing the signal evaluation unit; and
wherein the magnetic field sensor and the dimensional scale are arranged in a flush manner at a middle axis of the shaft and the first and the second elements of the energy generation unit are arranged spaced apart radially from the middle axis.

15. The rotary encoder in accordance with claim 14, wherein the dimensional scale is formed from the first element of the energy generation unit.

16. The rotary encoder in accordance with claim 1, wherein the signal evaluation unit has a rectifier circuit in order to rectify an alternating voltage generated by the energy generation unit and an energy store for the storage of electrical energy generated by the energy generation unit.

17. The rotary encoder in accordance with claim 1, wherein the signal evaluation unit has a state monitoring unit and a communication unit in order to communicate data detected by the signal detection unit to the control.

18. The rotary encoder in accordance with claim 17, wherein the communication unit is wireless.

19. The rotary encoder in accordance with claim 1, wherein the signal encoding unit has a transmission fastened at the shaft and the first element of the energy generation unit is attached to a transmission element of the transmission such that the first element of the energy generation unit attached at the transmission element is arranged disposed opposite to the second element of the energy generation unit.

20. The rotary encoder in accordance with claim 19, wherein the first element of the energy generation unit is attached at a planetary carrier of the transmission.
